(19) United States
(12) Patent Application Publication
(10) Pub. No.: US 2008/0057250 A1
(43) Pub. Date: Mar. 6, 2008

(54) Decoration panel

(76) Inventor: Chen-Fu Peng, Jhonghe City (TW)

Correspondence Address: TROXELL LAW OFFICE PLLC, SUITE 1404, 5205 LEESBURG PIKE, FALLS CHURCH, VA, 22041, US

(21) Appl. No.: 11/514,330

(22) Filed: Sep. 1, 2006

(51) Int. Cl. B32B 33/00; B32B 15/08

(52) U.S. Cl. 428/40.1; 428/457; 428/344; 428/422; 428/141; 428/913.3

(57) ABSTRACT

A decoration panel comprised of a metal base layer, a layer that is flame retard, and water and oil stains proof disposed on the front of the metal base layer, and an adhesion layer disposed on the back of the metal base layer for the panel to be attached to the surface of a dinning table, surface of kitchenware or kitchen wall to achieve results of flame retard, and fending off water and oil stains.

### BACKGROUND OF THE INVENTION

(a) Field of the Invention

The present invention is related to a decoration panel, and more particularly to one that is adhered to dinning table, kitchenware, or kitchen wall for its surface not liable to oil stains or water.

(b) Description of the Prior Art

Decoration panels are comprehensively applied in daily life either to the office furniture, kitchenware or interior decoration. To appear more attractive, the panel is usually printed with decorative design or pattern. However, the conventional decoration panel usually comprised of single layer of paper or PVC material with glue coated on its back is found with the following defectives:
1. The single paper or PVC layer does not provide fireproof and flame retard functions; on the contrary, it supports combustion, meaning once contacting a tongue of flame, it could easily combust to lead to fire disaster. Meanwhile, combustion of PVC could produce toxic gases deadly to human life. Therefore, the conventional paper or PVC decoration panel is extremely unsafe and impractical.
2. The paper material of the panel makes it not waterproof with extremely poor damp and friction withstanding properties, leading to poor adhesion so that the panel is liable to strip off easily to compromise its service life and fail to protect the surface adhered with the panel.
3. Any oil stain or water or dirt once gets attached to the paper or PVC panel becomes stubborn on the surface of the panel to permit easy clean.

### SUMMARY OF THE INVENTION

The primary purpose of the present invention is to provide an improved construction of the decoration panel adhered to the surface of a dinning table, kitchenware or kitchen wall that is flame retard and fends off water and oil stains.

To achieve the purpose, a decoration panel of the present invention is comprised of a metal base layer, a layer that is flame retard, and water and oil stains proof disposed on the front of the metal base layer, and an adhesion layer disposed on the back of the metal base layer for the panel to be attached to the surface of an object including a dinning table, kitchenware, or kitchen wall to achieve results of flame retard, and fending off water and oil stains.

### BRIEF DESCRIPTION OF THE DRAWINGS

FIG. 1 is a schematic view showing a construction of a first preferred embodiment of the present invention.

FIG. 2 is a schematic view showing a construction of a second preferred embodiment of the present invention.

FIG. 3 is a schematic view showing a status of use of the present invention.

FIG. 4 is a schematic view showing another status of use of the present invention.

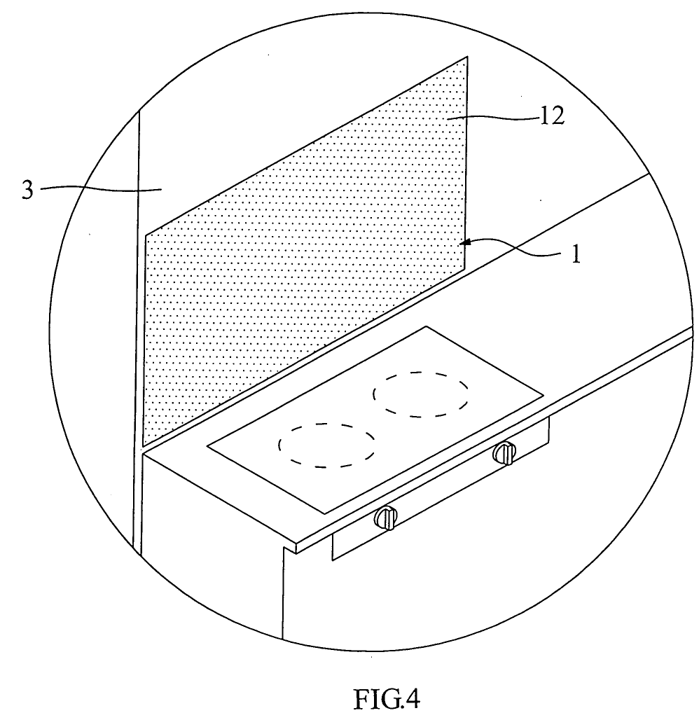

FIG. 5 is a schematic view showing a construction of a third preferred embodiment of the present invention.

FIG. 6 is a schematic view showing a construction of a fourth preferred embodiment of the present invention.

FIG. 7 is a schematic view showing another status of use yet of the present invention.

### DETAILED DESCRIPTION OF THE PREFERRED EMBODIMENTS

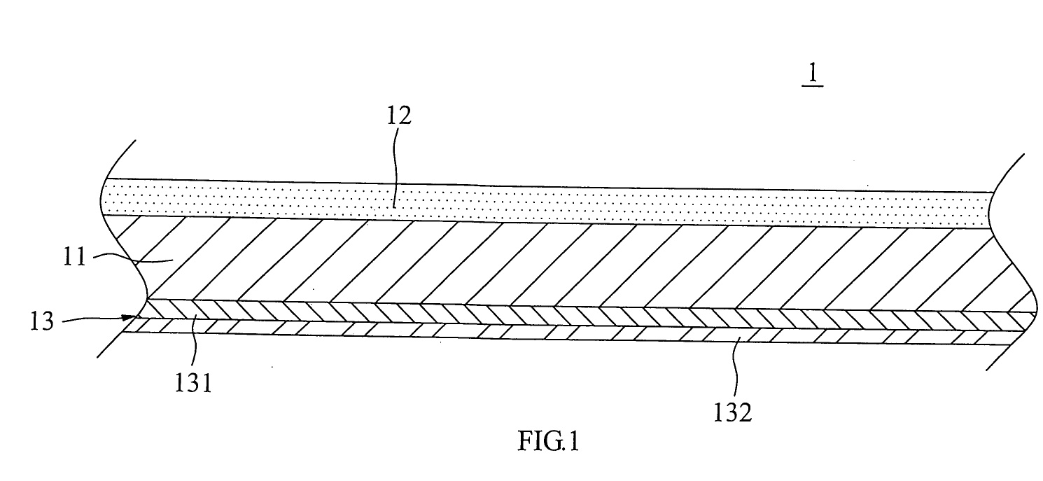

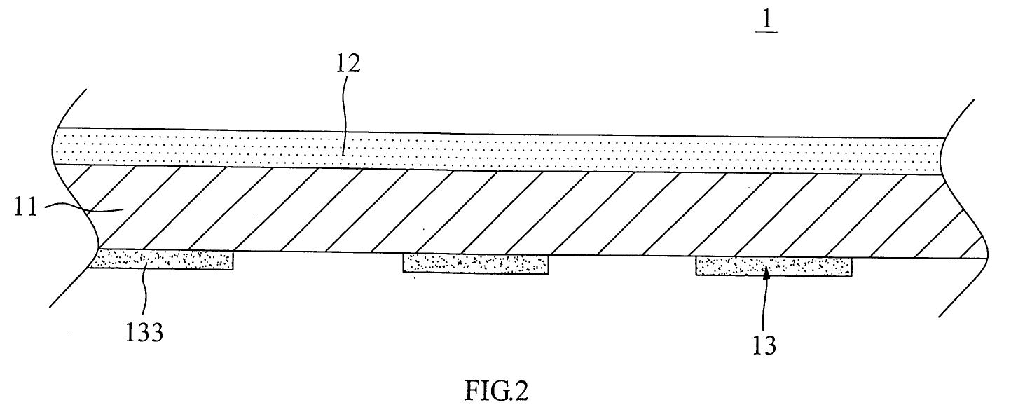

Referring to FIG. 1 for a first preferred embodiment of the present invention, a decoration panel 1 is comprised of a metal base layer 1, a flame retard layer 12 that is water and oil stain proof at the same time, and an adhesion layer 13. In the first preferred embodiment, the metal base layer 11 related to aluminum or copper sheet; the flame retard layer 12 is related to a Teflon layer by spraying Teflon on the front of the metal base layer 11; and the adhesion layer 13 comprised of a glued layer 131 and a strip off layer 132 is disposed on the back of the metal base layer 11. The adhesion layer 13 may be coated all over the back of the metal base layer 11 or in the form of an adhesion agent 133 disposed to a particular location on the back of the metal base layer 11 as illustrated in FIG. 2.

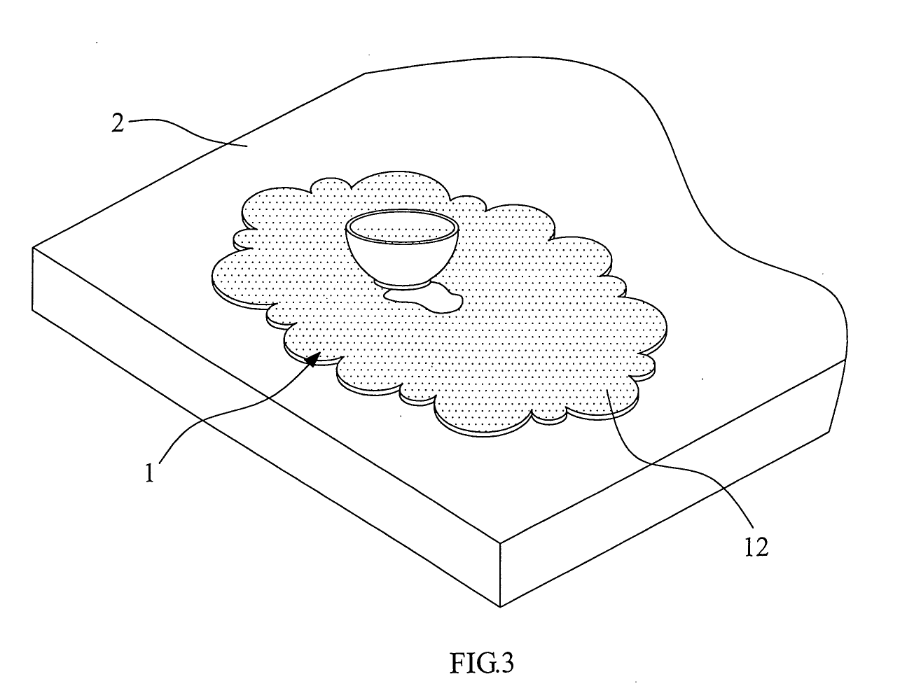

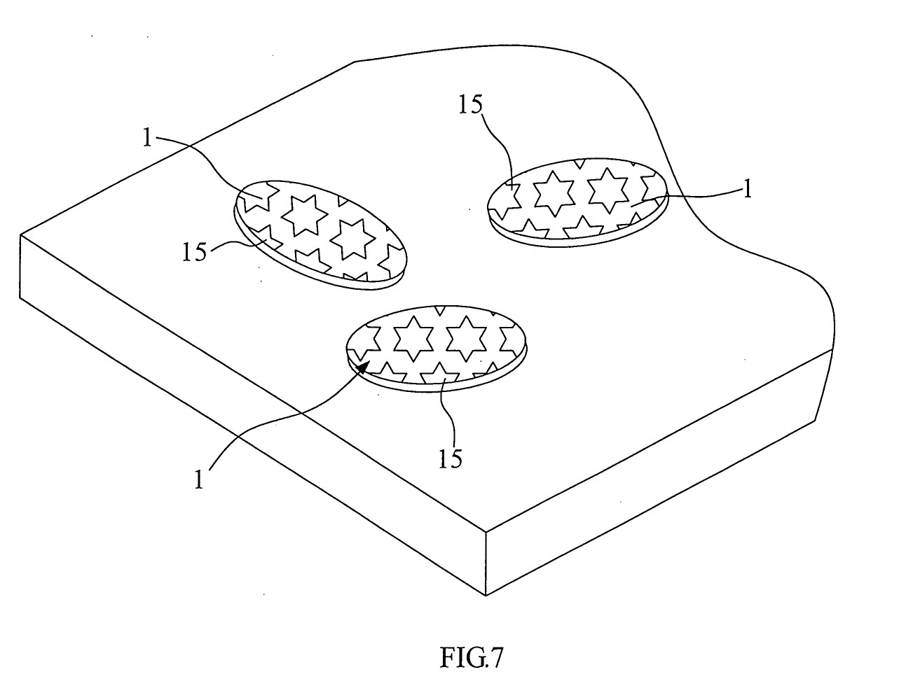

As illustrated in FIG. 3, the strip off layer is removed from the adhesion layer 13 for the adhesion layer to be attached to a surface of an object with the glued layer 131, or the adhesion layer 13 is forthwith attached to the surface of the object with the adhesive agent applied on the adhesion layer 13. As illustrated in FIG. 3, the decoration panel 1 is adhered to the surface of a dinning table, or is adhered to a kitchen wall 3 to allow easy clean of water or oil stains found on the surface of the decoration panel 1 in the course of dinning or cooking to achieve purposes of flame retard, and water and oil stains proof while keeping off any contamination. The metal base layer provides better flexibility for the decoration panel 1 to facilitate attaching it to the surface of an object by compromising the contour of the object. The decoration panel 1 may be cut into a given size to become a dish pad on the dinning table as illustrated in FIG. 7. The decoration panel 1 may be further provided various designs and patterns to become more attractive.

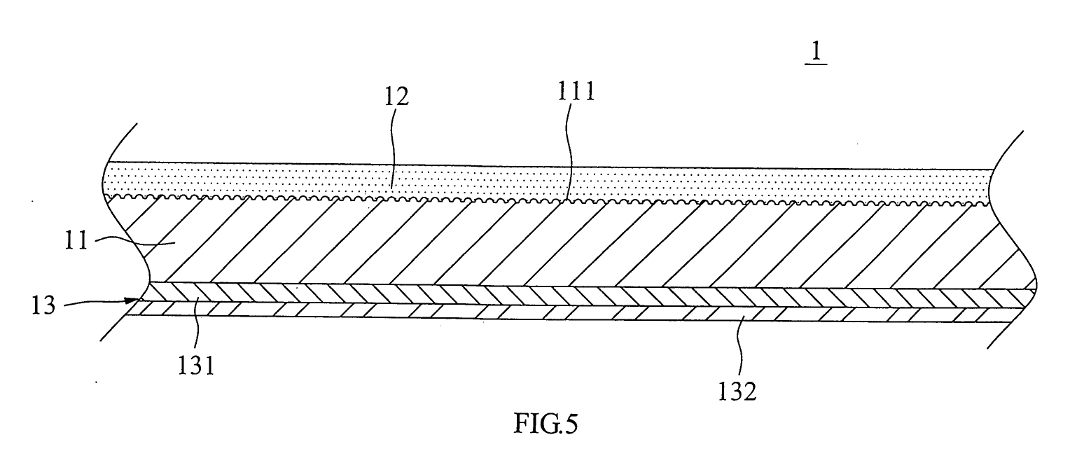

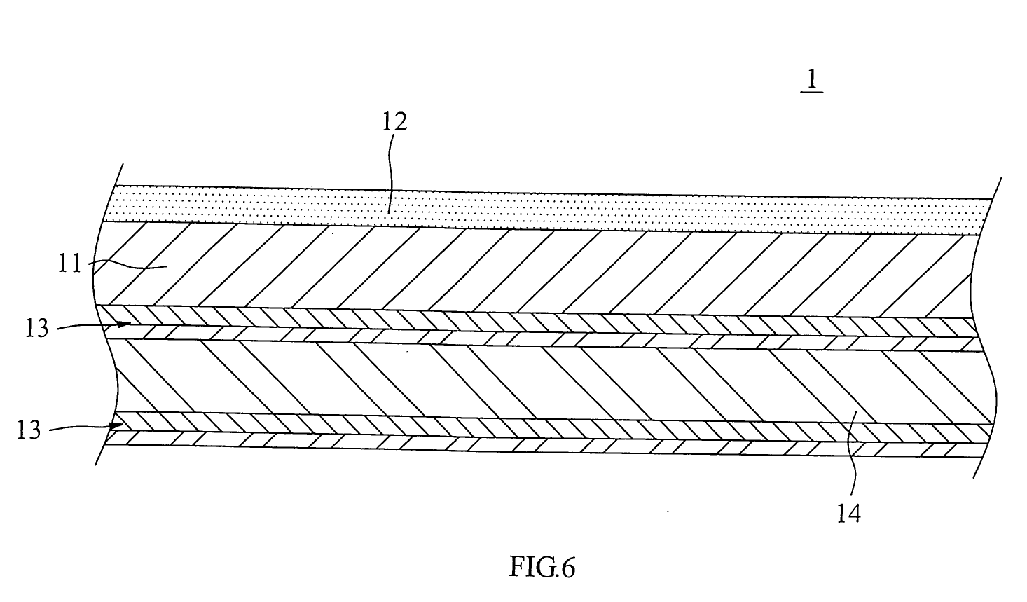

Furthermore, before spraying Teflon on the front of the metal base layer, sandblasting method is used to form multiple nipples 111 thereon as illustrated in FIG. 5. Accordingly, the flame retard layer 12 after the formation by spraying Teflon provides better adhesion force between the flame retard layer and the metal base layer 11 to prevent from being liable to strip off. The metal base layer 11 may be further attached to the front of a fiberglass layer 14 by the adhesion layer 13 as illustrated in FIG. 6. Another adhesion layer 13 is disposed to the bottom of the fiberglass layer 14 to provide the same results of flame retard, water and oil stains proof.

The prevent invention provides an improved structure of a decoration panel, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A decoration panel comprised of a metal base layer, a layer that is flame retard, and water and oil stains proof s disposed on the front of the metal base layer, and an adhesion layer disposed on the back of the metal base layer for the panel to be attached to the surface of an object to achieve results of flame retard, and fending off water and oil stains.

2. The decoration panel as claimed in claim 1, wherein the metal base layer relates to an aluminum or copper sheet.

3. The decoration panel as claimed in claim 1, wherein the layer that is flame retard and water and oil stains proof is related to a Teflon layer.

4. The decoration panel as claimed in claim 1, wherein the adhesion layer is provided with a glue layer and a strip off layer.

5. The decoration panel as claimed in claim 1, wherein the adhesion layer is applied with an adhesive agent.

6. The decoration panel as claimed in claim 1, wherein the adhesion layer is coated over the back of the metal base layer or disposed to a particular location on the back of the metal base layer.

7. The decoration panel as claimed in claim 1, wherein multiple nipples are provided on the front of the metal base layer.

8. The decoration panel as claimed in claim 1, wherein multiple nipples are formed on the front of the metal base layer by using a sandblasting method.

9. The decoration panel as claimed in claim 1, wherein the middle layer that is flame retard and water and oil stain proof is comprised of spraying Teflon thereon.

10. The decoration panel as claimed in claim 1, wherein the metal base layer is further attached to the front of a fiberglass layer with an adhesion layer.

11. The decoration panel as claimed in claim 10, wherein an adhesion layer is disposed to the bottom of the fiberglass layer.

12. The decoration panel as claimed in claim 1, wherein the surface of the decoration panel is provided with a design or pattern.
